(19) United States
(12) Patent Application Publication
(10) Pub. No.: US 2018/0178917 A1
(43) Pub. Date: Jun. 28, 2018

(54) STRUCTURE FOR PROPULSIVE AIRCRAFT ASSEMBLY, ASSOCIATED PROPULSIVE SYSTEM AND ASSEMBLY

(71) Applicant: Airbus Operations S.A.S., Toulouse (FR)

(72) Inventors: Florian Ravise, Saint-Herblain (FR); Hassan Menay, Nantes (FR)

(73) Assignee: Airbus Operations S.A.S., Toulouse (FR)

(21) Appl. No.: 15/840,047

(22) Filed: Dec. 13, 2017

(30) Foreign Application Priority Data
Dec. 27, 2016 (FR) 16 63427

(51) Int. Cl. B64D 15/12; B64D 33/02; F02C 7/047; F01D 25/00

(52) U.S. Cl. CPC B64D 15/12; B64D 33/02; F02C 7/047; F01D 25/005; B64D 2033/0206; B32B 2605/18; B64D 2033/0273; F05D 2300/603; B32B 2305/18; B32B 2307/202; B64D 2033/0233

(57) ABSTRACT

A structure made of composite material for a propulsive aircraft assembly includes at least one thermal zone designed to receive electrical energy. Each thermal zone includes at least one resistive skin having an inner film produced in a thermoplastic material made conductive by the inclusion of carbon nanotubes, such that each resistive skin is designed to dissipate, by Joule effect, at least a portion of the electrical energy received by the thermal zone, an intermediate ply produced in a satin fabric impregnated with a thermoplastic material, and an outer film produced in a thermoplastic material.

### FIELD OF THE INVENTION

The present invention relates to a structure made of composite material for a propulsive aircraft assembly, the structure comprising at least one thermal zone designed to receive electrical energy. The invention also relates to a system comprising such a structure, a propulsive assembly and a method for manufacturing such a structure.

The invention applies to the field of propulsive aircraft assemblies, and more particularly to structures arranged in such propulsive assemblies, for example acoustic panels.

### BACKGROUND OF THE INVENTION

It is known practice to provide a propulsive assembly, at its air inlet, with a lip intended to prevent the formation of ice. In effect, such a formation of ice is likely to modify the aerodynamic characteristics of the propulsive assembly and degrade the performance levels thereof.

It is also known practice to provide a propulsive assembly with an acoustic panel. Such a panel is a composite structure intended to reduce the noise generated by a turbine engine present in the propulsive assembly when it is operating.

Nevertheless, such propulsive assemblies do not give full satisfaction. Indeed, in such propulsive assemblies, it is generally difficult to extend the acoustic panel towards the air inlet in order to offer a greater attenuation of the noise generated by the turbine engine. In effect, the space available for the acoustic panel is limited, downstream of the acoustic panel in the direction of flow of the air stream generated by the turbine engine, by a first row of blades of the jet engine, and upstream of the acoustic panel by the lip. It is therefore not easy to reduce the level of noise generated by such a turbine engine.

### BRIEF SUMMARY OF THE INVENTION

One idea of the invention is therefore to propose a propulsive assembly in which the acoustic attenuation is enhanced.

A subject of the invention is a structure of the abovementioned type, in which that each thermal zone comprises at least one resistive skin comprising an inner film produced in a thermoplastic material made conductive by the inclusion of carbon nanotubes, such that each resistive skin is designed to dissipate, by Joule effect, at least a portion of the electrical energy received by the thermal zone, an intermediate ply produced in a satin fabric impregnated with a thermoplastic material, and an outer film produced in a thermoplastic material.

In effect, in the case where such a structure is an acoustic panel, the acoustic panel is designed to produce heat, intended to prevent the formation of ice. Consequently, by virtue of such a structure, the extension of the acoustic panel upstream is possible.

Consequently, such an acoustic panel is designed to ensure a greater attenuation of the noise generated by the turbine engine, while preventing the formation of ice in the propulsive assembly.

According to another advantageous aspect of the invention, the structure is an acoustic panel.

Furthermore, another subject of the invention is a system for propulsive assembly comprising a structure as defined above, and a power supply circuit configured to convey electrical energy from a source of electrical energy to each thermal zone of the structure.

According to other advantageous aspects of the invention, the system comprises one or more of the following features, taken alone or in all technically possible combinations:
the power supply circuit comprises anchoring members intended to ensure the fixing of the structure, the anchoring members comprising at least one electrically conductive surface in electrical contact with each thermal zone to convey electrical energy to each thermal zone;
each surface of the anchoring members is welded to each thermal zone by at least one electrically conductive weld.

Furthermore, yet another subject of the invention is a propulsive assembly comprising a system as defined above.

According to another advantageous aspect of the invention, each thermal zone of the structure at least partially delimits a fluid flow channel.

### BRIEF DESCRIPTION OF THE DRAWINGS

The invention will be better understood from the following description, given purely as a nonlimiting example and with reference to the attached drawings in which:

FIG. 1 is a sectional view of a propulsive assembly according to an embodiment of the invention, in a longitudinal plane of the propulsive assembly;

FIG. 2 is a detail of the view of FIG. 1; and

FIG. 3 is a front view of an inner surface of a structure according to an embodiment of the invention.

### DETAILED DESCRIPTION

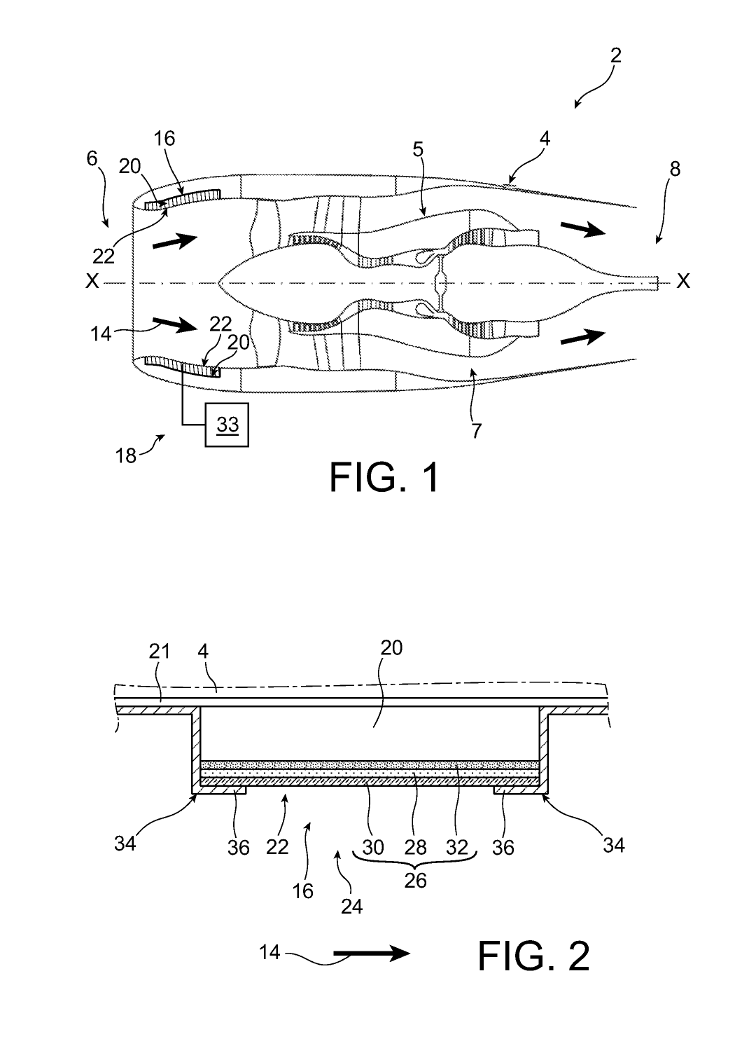

A propulsive assembly 2 according to an embodiment of the invention is represented in FIG. 1.

The propulsive assembly 2 comprises a nacelle 4 and a turbine engine, for example a jet engine 5.

The nacelle 4 surrounds the jet engine 5 and externally delimits a fluid flow channel comprising an air inlet channel 6, a secondary stream 7 and an exhaust channel 8.

The jet engine 5 is intended to generate, in its operation, an air stream 14 flowing from the inlet channel 6 to the exhaust channel 8. The air stream 14 is illustrated by a set of arrows in FIG. 1.

The propulsive assembly 2 further comprises at least one structure 16 made of composite material and an electrical energy power supply circuit 18 for the structure 16.

“Composite material” should be understood, in the sense of the present invention, to be a resin in which fibres are captive. Such a material is, for example, known as “Fibre Reinforced Plastic”. The fibres are produced in carbon, in glass or even in aramid. The resin is a thermosetting resin (of epoxy resin type) or even a thermoplastic resin (for example polyetheretherketone, or PEEK, a polyetherimide, or PEI, or even polyetherketoneketone, or PEKK).

The structure 16 is configured to receive electrical energy and to dissipate at least a portion of the electrical energy received in the form of thermal energy.

The power supply circuit 18 is configured to supply electrical energy to the structure 16.

The structure 16 is incorporated in the nacelle 4, for example to delimit at least one axial section of the air inlet channel 6.

For example, the structure 16 is an acoustic panel. In this case, the structure 16 advantageously has an annular form, or is composed of an assembly of panels in the form of ring portions mounted end-to-end circumferentially.

The structure 16 comprises a core 20, an outer surface 21 and an inner surface 22.

The core 20 is arranged between the outer surface 21 and the inner surface 22, in contact with the outer surface 21 and the inner surface 22.

For example, in the case where the structure 16 is an acoustic panel, the core 20 has a honeycomb structure of known type.

The outer surface 21 is, for example, that, out of the outer surface 21 and the inner surface 22, which is arranged on a radially outer side of the propulsive assembly 2.

For example, the inner surface 22 is that, out of the outer surface 21 and the inner surface 22, which is arranged on a radially inner side of the propulsive assembly 2, as illustrated by FIG. 1. Thus, the inner surface 22 is intended to enter into contact with the air stream 14.

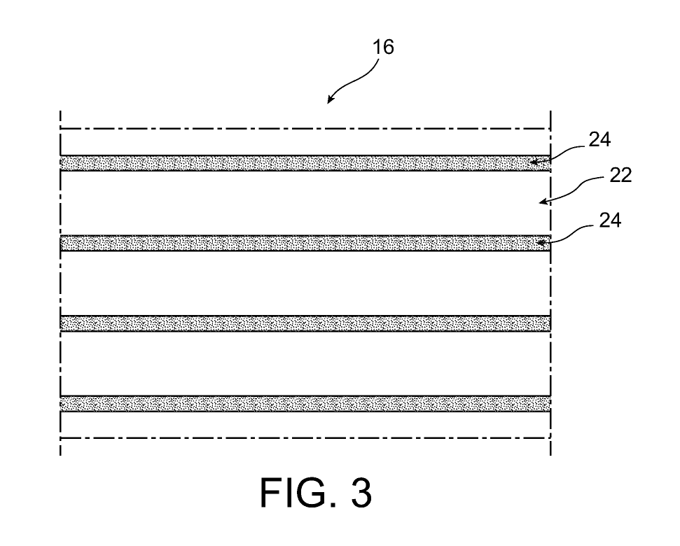

Referring to FIGS. 2 and 3, the inner surface 22 comprises at least one thermal zone 24.

The thermal zone 24 is designed to receive the electrical energy supplied by the power supply circuit 18. The thermal zone 24 is also designed to dissipate, in the form of thermal energy, at least a portion of the electrical energy received from the power supply circuit 18.

Advantageously, the thermal zone 24 is designed to dissipate at least a portion of the electrical energy received in the form of thermal energy by Joule effect. In this case, and as represented in FIG. 3, the thermal zone 24 comprises a resistive skin 26 designed to dissipate, by Joule effect, at least a portion of the electrical energy received from the power supply circuit 18 in the form of thermal energy.

The resistive skin 26 is, for example, obtained by roll bonding an intermediate ply 28 between an inner film 30, arranged on the side of the air stream 14, and an outer film 32, arranged on the side opposite the air stream 14, as is shown in FIG. 2.

As an example, each resistive skin 26 is, for example, in the form of strips.

For example, the intermediate ply 28 is produced in a satin fabric impregnated with a thermoplastic material in order to provide mechanical support for the inner film 30. Furthermore the intermediate ply 28 contribute to the protection of the resistive skin 26 from erosion.

For example, the outer film 32 is produced in a thermoplastic material, and ensures cohesion of the resistive skin 26 to the core 20.

For example, the inner film 30 is produced in a thermoplastic material made conductive by the inclusion of carbon nanotubes.

For example, the thermoplastic material is polyetherimide.

Obviously, a thermosetting material, for example based on epoxy resin, can be used.

The power supply circuit 18 is configured to convey electrical energy to the structure 16 from a source 33 of electrical energy.

Advantageously, the power supply circuit 18 comprises anchoring members 34 for the structure 16, intended to hold the structure 16 in place. In this case, the anchoring members 34 comprise at least one surface 36 designed to be in contact with the thermal zone 24. Each surface 36 is produced in an electrically conductive material to allow the flow of electrical energy between the power supply circuit 18 and the thermal zone 24.

Preferably, the surfaces 36 are welded to the thermal zone 24 by means of at least one electrically conductive weld (not represented).

Such a structure 16 is designed to dissipate heat to prevent the formation of ice. Furthermore, the presence of carbon nanotubes in the inner face 22 of the structure 16 is likely to enhance the erosion-resistance of the structure 16.

Thus, with such a de-icing solution, an enlargement of the acoustic panel upstream of the air inlet is possible, which makes it possible to optimize the noise reduction.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A structure made of composite material for a propulsive aircraft assembly, the structure comprising at least one thermal zone configured to receive electrical energy,
wherein the at least one thermal zone comprises at least one resistive skin comprising:
an inner film produced in a thermoplastic material made conductive by the inclusion of carbon nanotubes, such that each resistive skin is configured to dissipate, by Joule effect, at least a portion of the electrical energy received by the at least one thermal zone;
an intermediate ply produced in a satin fabric impregnated with a thermoplastic material; and
an outer film produced in a thermoplastic material.

2. The structure according to claim 1, wherein the structure is an acoustic panel.

3. A system for propulsive assembly comprising a structure according to claim 1, and a power supply circuit configured to convey electrical energy from a source of electrical energy to each thermal zone of the structure.

4. The system according to claim 3, wherein the power supply circuit comprises anchoring members configured to ensure the fixing of the structure, the anchoring members comprising at least one electrically conductive surface in electrical contact with the at least one thermal zone to convey electrical energy to the at least one thermal zone.

5. The system according to claim 4, wherein each surface of the anchoring members is welded to the at least one thermal zone by at least one electrically conductive weld.

6. A propulsive assembly comprising a system according to claim 3.

7. The propulsive assembly according to claim 6, wherein the at least one thermal zone of the structure at least partially delimits a fluid flow channel.
